(19) United States
(12) Patent Application Publication
(10) Pub. No.: US 2016/0026294 A1
(43) Pub. Date: Jan. 28, 2016

(54) TOUCH PANEL AND METHOD FOR ARRANGING ELECTRODE THEREOF

(71) Applicant: Novatek Microelectronics Corp., Hsinchu (TW)

(72) Inventors: Wing-Kai Tang, Hsinchu City (TW); Chih-Chang Lai, Taichung City (TW); Ching-Yang Pai, Taipei City (TW)

(21) Appl. No.: 14/670,432

(22) Filed: Mar. 27, 2015

(30) Foreign Application Priority Data
Jul. 25, 2014 (TW) 103125527

(51) Int. Cl. G06F 3/044

(52) U.S. Cl. CPC G06F 3/044

(57) ABSTRACT

A touch panel and a method of arranging electrodes thereof are provided. The touch panel includes a plurality of touch patterns. The touch patterns are arranged in an array and respectively include a first transmitter electrode, a second transmitter electrode, and a plurality of receiver electrodes. The second transmitter electrode is parallel to the first transmitter electrode. The receiver electrodes are disposed between the first transmitter electrode and the second transmitter electrode and are respectively adjacent to the first transmitter electrode and the second transmitter electrode. The first transmitter electrode, the second transmitter electrode, and the receiver electrodes do not overlap each other. The first transmitter electrodes of the touch patterns are not connected with each other. The second transmitter electrodes of the touch patterns are not connected with each other.

### CROSS-REFERENCE TO RELATED APPLICATION

This application claims the priority benefit of Taiwan application serial no. 103125527, filed on Jul. 25, 2014. The entirety of the above-mentioned patent application is hereby incorporated by reference herein and made a part of this specification.

### BACKGROUND OF THE INVENTION

1. Field of the Invention

The invention relates to a touch panel and more particularly relates to a capacitive touch panel and a method of arranging electrodes thereof.

2. Description of Related Art

Thanks to the rapid development of touch technology, touch devices, such as mobile phones, laptop computers, and tablet computers, provide intuitive operation and input interfaces, and thus have become popular among the consumers and create many business opportunities. Touch devices may be categorized into two types, i.e. capacitive touch type and resistive touch type, depending on the touch sensing methods. The capacitive touch has advantages in higher sensitivity and longer lifespan.

The capacitive touch mainly utilizes a conductive touch medium to touch a touch panel, so as to create an additional capacitance on the corresponding electrode and thereby cause an equivalent capacitance of the touched electrode to change. Then, a back-end sensor IC can determine a touched position on the touch panel according to the change of the equivalent capacitance of the touched electrode. Because the electrodes on the touch panel are electrically connected to the sensor IC through wires, the equivalent capacitance between the wires and the electrodes would affect the sensed capacitance value, which results in non-uniform capacitance distribution of the touch panel and influences the determination of the touched point. Therefore, how to rearrange the wires and the electrodes to reduce the influence the wires cause to touch point determination is an important issue in the field of design of touch panel.

### SUMMARY OF THE INVENTION

The invention provides a touch panel and a method of arranging electrodes thereof for reducing the influence that wiring causes to touch point determination and lowering the overall hardware costs of the touch panel.

The touch panel of the invention includes a plurality of touch patterns. The touch patterns are arranged in an array and respectively include a first transmitter electrode, a second transmitter electrode, and a plurality of receiver electrodes. The second transmitter electrode is parallel to the first transmitter electrode. The receiver electrodes are disposed between the first transmitter electrode and the second transmitter electrode and are respectively adjacent to the first transmitter electrode and the second transmitter electrode. The first transmitter electrode, the second transmitter electrode, and the receiver electrodes do not overlap each other. The first transmitter electrodes of the touch patterns are not connected with each other. The second transmitter electrodes of the touch patterns are not connected with each other.

In an embodiment of the invention, in each of the touch patterns, the first transmitter electrode is electrically connected with the second transmitter electrode.

In an embodiment of the invention, in each of the touch patterns, the first transmitter electrode is not connected with the second transmitter electrode.

In an embodiment of the invention, in each of the touch patterns, the receiver electrodes include a first receiver electrode and a second receiver electrode that are arranged in sequence in a first direction, wherein the first receiver electrodes of the touch patterns are electrically connected with each other and the second receiver electrodes of the touch patterns are electrically connected with each other.

In an embodiment of the invention, in each of the touch patterns, the receiver electrodes further include a third receiver electrode, and the first receiver electrode, the second receiver electrode, and the third receiver electrode are arranged in sequence in the first direction, wherein the third receiver electrodes of the touch patterns are electrically connected with each other.

In an embodiment of the invention, a sequence of arrangement of the first receiver electrode, the second receiver electrode, and the third receiver electrode of each of the touch patterns is the same as a sequence of arrangement of the first receiver electrode, the second receiver electrode, and the third receiver electrode of the adjacent touch pattern in the first direction.

In an embodiment of the invention, the sequence of arrangement of the first receiver electrode, the second receiver electrode, and the third receiver electrode of each of the touch patterns is opposite to the sequence of arrangement of the first receiver electrode, the second receiver electrode, and the third receiver electrode of the adjacent touch pattern in the first direction.

In an embodiment of the invention, one of the first receiver electrode and the third receiver electrode of each of the touch patterns is in contact with one of the first receiver electrode and the third receiver electrode of the adjacent touch pattern in the first direction.

In an embodiment of the invention, in each of the touch patterns, the receiver electrodes further include a fourth receiver electrode, and the first receiver electrode, the second receiver electrode, the third receiver electrode, and the fourth receiver electrode are arranged in sequence in the first direction, wherein the fourth receiver electrodes of the touch patterns are electrically connected with each other.

In an embodiment of the invention, a sequence of arrangement of the first receiver electrode, the second receiver electrode, the third receiver electrode, and the fourth receiver electrode of each of the touch patterns is the same as a sequence of arrangement of the first receiver electrode, the second receiver electrode, the third receiver electrode, and the fourth receiver electrode of the adjacent touch pattern in the first direction.

In an embodiment of the invention, the sequence of arrangement of the first receiver electrode, the second receiver electrode, the third receiver electrode, and the fourth receiver electrode of each of the touch patterns is opposite to the sequence of arrangement of the first receiver electrode, the second receiver electrode, the third receiver electrode, and the fourth receiver electrode of the adjacent touch pattern in the first direction.

In an embodiment of the invention, one of the first receiver electrode and the fourth receiver electrode of each of the touch patterns is in contact with one of the first receiver electrode and the fourth receiver electrode of the adjacent touch pattern in the first direction.

A touch panel of the invention includes a plurality of touch patterns. The touch patterns are arranged in an array and respectively include a transmitter electrode and a plurality of receiver electrodes. The receiver electrodes are disposed evenly on a first side and a second side of the transmitter electrode and adjacent to the transmitter electrode. The first side is opposite to the second side. The transmitter electrode and the receiver electrodes do not overlap each other. The transmitter electrodes of the touch patterns are not connected with each other.

In an embodiment of the invention, in each of the touch patterns, the receiver electrodes include a first receiver electrode, a second receiver electrode, a third receiver electrode, and a fourth receiver electrode. The first receiver electrode and the second receiver electrode are disposed on the first side and arranged in sequence in a first direction, and the third receiver electrode and the fourth receiver electrode are disposed on the second side and arranged in sequence in the first direction, wherein the first receiver electrodes of the touch patterns are electrically connected with each other, the second receiver electrodes of the touch patterns are electrically connected with each other, the third receiver electrodes of the touch patterns are electrically connected with each other, and the fourth receiver electrodes of the touch patterns are electrically connected with each other.

In an embodiment of the invention, in each of the touch patterns, the receiver electrodes include a first receiver electrode, a second receiver electrode, a third receiver electrode, a fourth receiver electrode, a fifth receiver electrode, and a sixth receiver electrode. The first receiver electrode, the second receiver electrode, and the third receiver electrode are disposed on the first side and arranged in sequence in the first direction, and the fourth receiver electrode, the fifth receiver electrode, and the sixth receiver electrode are disposed on the second side and arranged in sequence in the first direction, wherein the first receiver electrodes of the touch patterns are electrically connected with each other, the second receiver electrodes of the touch patterns are electrically connected with each other, the third receiver electrodes of the touch patterns are electrically connected with each other, the fourth receiver electrodes of the touch patterns are electrically connected with each other, the fifth receiver electrodes of the touch patterns are electrically connected with each other, and the sixth receiver electrodes of the touch patterns are electrically connected with each other.

In an embodiment of the invention, a sequence of arrangement of the first receiver electrode, the second receiver electrode, and the third receiver electrode of each of the touch patterns is the same as a sequence of arrangement of the first receiver electrode, the second receiver electrode, and the third receiver electrode of the adjacent touch pattern in the first direction; and a sequence of arrangement of the fourth receiver electrode, the fifth receiver electrode, and the sixth receiver electrode of each of the touch patterns is the same as a sequence of arrangement of the fourth receiver electrode, the fifth receiver electrode, and the sixth receiver electrode of the adjacent touch pattern in the first direction.

In an embodiment of the invention, the sequence of arrangement of the first receiver electrode, the second receiver electrode, and the third receiver electrode of each of the touch patterns is opposite to the sequence of arrangement of the first receiver electrode, the second receiver electrode, and the third receiver electrode of the adjacent touch pattern in the first direction; and the sequence of arrangement of the fourth receiver electrode, the fifth receiver electrode, and the sixth receiver electrode of each of the touch patterns is opposite to the sequence of arrangement of the fourth receiver electrode, the fifth receiver electrode, and the sixth receiver electrode of the adjacent touch pattern in the first direction.

In an embodiment of the invention, one of the first receiver electrode and the third receiver electrode of each of the touch patterns is in contact with one of the first receiver electrode and the third receiver electrode of the adjacent touch pattern in the first direction; and one of the fourth receiver electrode and the sixth receiver electrode of each of the touch patterns is in contact with one of the fourth receiver electrode and the sixth receiver electrode of the adjacent touch pattern in the first direction.

In an embodiment of the invention, in each of the touch patterns, the receiver electrodes include a first receiver electrode, a second receiver electrode, a third receiver electrode, a fourth receiver electrode, a fifth receiver electrode, a sixth receiver electrode, a seventh receiver electrode, and an eighth receiver electrode. The first receiver electrode, the second receiver electrode, the third receiver electrode, and the fourth receiver electrode are disposed on the first side and arranged in sequence in the first direction, and the fifth receiver electrode, the sixth receiver electrode, the seventh receiver electrode, and the eighth receiver electrode are disposed on the second side and arranged in sequence in the first direction, wherein the first receiver electrodes of the touch patterns are electrically connected with each other, the second receiver electrodes of the touch patterns are electrically connected with each other, the third receiver electrodes of the touch patterns are electrically connected with each other, the fourth receiver electrodes of the touch patterns are electrically connected with each other, the fifth receiver electrodes of the touch patterns are electrically connected with each other, the sixth receiver electrodes of the touch patterns are electrically connected with each other, the seventh receiver electrodes of the touch patterns are electrically connected with each other, and the eighth receiver electrodes of the touch patterns are electrically connected with each other.

In an embodiment of the invention, a sequence of arrangement of the first receiver electrode, the second receiver electrode, the third receiver electrode, and the fourth receiver electrode of each of the touch patterns is the same as a sequence of arrangement of the first receiver electrode, the second receiver electrode, the third receiver electrode, and the fourth receiver electrode of the adjacent touch pattern in the first direction; and a sequence of arrangement of the fifth receiver electrode, the sixth receiver electrode, the seventh receiver electrode, and the eighth receiver electrode of each of the touch patterns is the same as a sequence of arrangement of the fifth receiver electrode, the sixth receiver electrode, the seventh receiver electrode, and the eighth receiver electrode of the adjacent touch pattern in the first direction.

In an embodiment of the invention, the sequence of arrangement of the first receiver electrode, the second receiver electrode, the third receiver electrode, and the fourth receiver electrode of each of the touch patterns is opposite to the sequence of arrangement of the first receiver electrode, the second receiver electrode, the third receiver electrode, and the fourth receiver electrode of the adjacent touch pattern in the first direction; and the sequence of arrangement of the fifth receiver electrode, the sixth receiver electrode, the seventh receiver electrode, and the eighth receiver electrode of each of the touch patterns is opposite to the sequence of arrangement of the fifth receiver electrode, the sixth receiver electrode, the seventh receiver electrode, and the eighth receiver electrode of the adjacent touch pattern in the first direction.

In an embodiment of the invention, one of the first receiver electrode and the fourth receiver electrode of each of the touch patterns is in contact with one of the first receiver electrode and the fourth receiver electrode of the adjacent touch pattern in the first direction; and one of the fifth receiver electrode and the eighth receiver electrode of each of the touch patterns is in contact with one of the fifth receiver electrode and the eighth receiver electrode of the adjacent touch pattern in the first direction.

An electrode arranging method of the invention is adapted for a touch panel, which includes a plurality of touch patterns each including a first transmitter electrode, a second transmitter electrode, and a plurality of receiver electrodes. The electrode arranging method includes the following. The second transmitter electrode is disposed in parallel to the first transmitter electrode. The receiver electrodes are disposed between the first transmitter electrode and the second transmitter electrode. Each of the receiver electrodes is respectively adjacent to the first transmitter electrode and the second transmitter electrode, wherein the first transmitter electrode, the second transmitter electrode, and the receiver electrodes do not overlap each other, and the first transmitter electrodes of the touch patterns are not connected with each other, and the second transmitter electrodes of the touch patterns are not connected with each other.

An electrode arranging method of the invention is adapted for a touch panel, which includes a plurality of touch patterns each including a transmitter electrode and a plurality of receiver electrodes. The electrode arranging method includes the following. The receiver electrodes are evenly disposed on a first side and a second side of the transmitter electrode such that the receiver electrodes are adjacent to the transmitter electrode, wherein the first side is opposite to the second side; the transmitter electrode and the receiver electrodes do not overlap each other; and the transmitter electrodes of the touch patterns are not connected with each other.

Based on the above, according to the touch panel and the electrode arranging method of the invention, in each of the touch patterns, the first transmitter electrode and the second transmitter electrode surround multiple receiver electrodes, and when the first transmitter electrode and the second transmitter electrode are electrically connected, the capacitance variation sensed due to touch is improved; or when the first transmitter electrode and the second transmitter electrode are not connected, multiple receiver electrodes are shared to reduce the number of the wires, thereby lowering the overall hardware costs of the touch panel.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A and FIG. 1B are schematic structural views of a touch panel according to the first embodiment of the invention.

FIG. 2A and FIG. 2B are schematic structural views of a touch panel according to the second embodiment of the invention.

FIG. 3A and FIG. 3B are schematic structural views of a touch panel according to the third embodiment of the invention.

FIG. 4A and FIG. 4B are schematic structural views of a touch panel according to the fourth embodiment of the invention.

FIG. 5A and FIG. 5B are schematic structural views of a touch panel according to the fifth embodiment of the invention.

FIG. 6A and FIG. 6B are schematic structural views of a touch panel according to the sixth embodiment of the invention.

FIG. 7A and FIG. 7B are schematic structural views of a touch panel according to the seventh embodiment of the invention.

FIG. 8A and FIG. 8B are schematic structural views of a touch panel according to the eighth embodiment of the invention.

FIG. 9A and FIG. 9B are schematic structural views of a touch panel according to the ninth embodiment of the invention.

### DESCRIPTION OF THE EMBODIMENTS

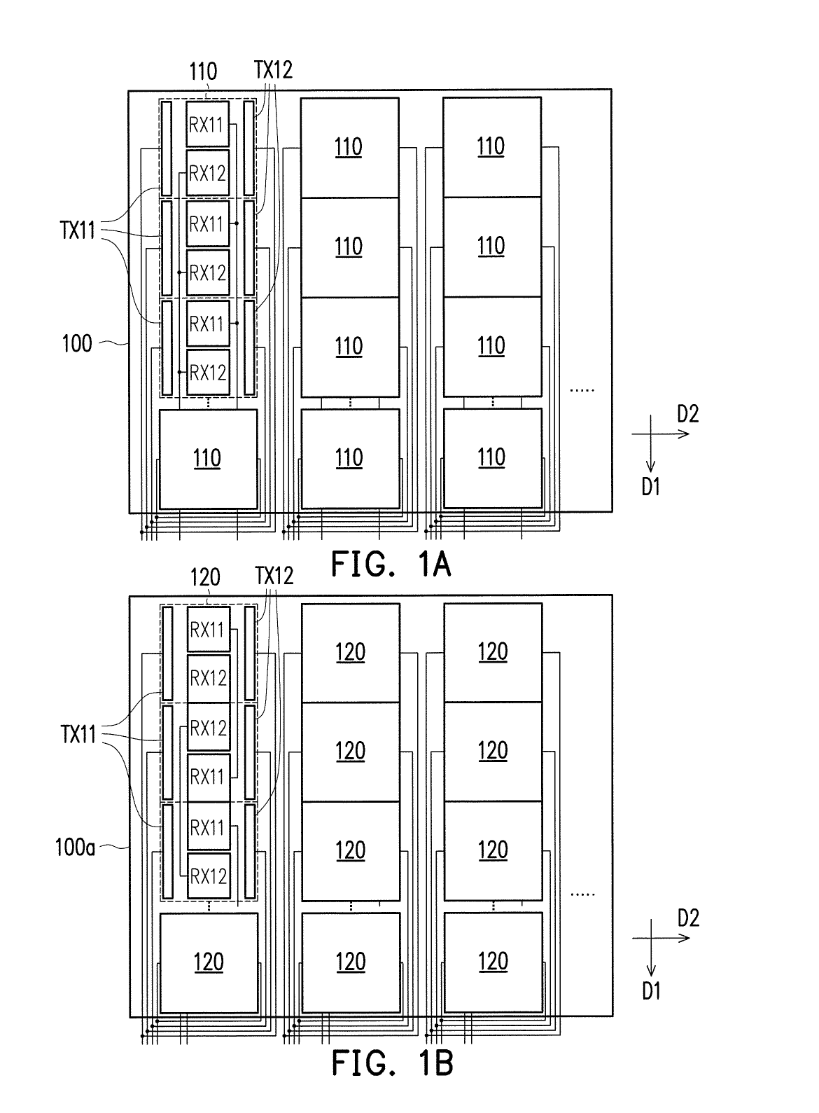

FIG. 1A and FIG. 1B are schematic structural views of a touch panel according to the first embodiment of the invention. With reference to FIG. 1A, in this embodiment, a touch panel 100 includes a plurality of touch patterns 110, for example, wherein the touch patterns 110 are arranged in an array and the touch patterns 110 respectively include a first transmitter electrode TX11, a second transmitter electrode TX12, and a plurality of receiver electrodes (e.g. a first receiver electrode RX11 and a second receiver electrode RX12). The first transmitter electrodes TX11, the second transmitter electrodes TX12, the first receiver electrodes RX11, and the second receiver electrodes RX12 do not overlap each other and may be disposed in the same layer.

In each of the touch patterns 110, the first transmitter electrode TX11 and the second transmitter electrode TX12 are disposed opposite to each other in a second direction D2, and the first transmitter electrode TX11 is electrically connected with the second transmitter electrode TX12. That is, the first transmitter electrode TX11 and the second transmitter electrode TX12 of the same touch pattern 110 receive a driving signal simultaneously. The first receiver electrode RX11 and the second receiver electrode RX12 are disposed between the first transmitter electrode TX11 and the second transmitter electrode TX12, wherein the first receiver electrode RX11 and the second receiver electrode RX12 are arranged in sequence in a first direction D1 (e.g. perpendicular to the second direction D2), and the sequence of arrangement of the first receiver electrode RX11 and the second receiver electrode RX12 is the same for all the touch patterns 110.

Furthermore, the first receiver electrode RX11 and the second receiver electrode RX12 are respectively adjacent to the first transmitter electrode TX11 and the second transmitter electrode TX12. That is, the first receiver electrode RX11 and the second receiver electrode RX12 perform touch sensing with the first transmitter electrode TX11 and the second transmitter electrode TX12 simultaneously. In other words, a horizontal sensing pitch of the touch panel 100 is from the left side of the first transmitter electrode TX11 to the right side of the second transmitter electrode TX12; and a vertical sensing pitch of the touch panel 100 is equal to the length of the first receiver electrode RX11 or the second receiver electrode RX12 in the first direction D1.

In terms of the entire touch panel 100, the first transmitter electrodes TX11 are not connected with each other, and the second transmitter electrodes TX12 are not connected with each other, either. That is, the touch patterns 110 correspond to different driving signals respectively. The first receiver electrodes RX11 are electrically connected with each other, and the second receiver electrodes RX12 are electrically connected with each other.

According to the above, wires connecting the receiver electrodes (e.g. the first receiver electrode RX11 and the second receiver electrode RX12) are respectively disposed between the receiver electrodes (e.g. the first receiver electrode RX11 and the second receiver electrode RX12) and the first transmitter electrode TX11 and between the receiver electrodes (e.g. the first receiver electrode RX11 and the second receiver electrode RX12) and the second transmitter electrode TX12. That is, every time touch sensing is performed, the receiver electrodes (e.g. the first receiver electrode RX11 and the second receiver electrode RX12) are affected by an equivalent capacitance of the wires. Therefore, a capacitance distribution of the touch panel 100 is uniformized to reduce the influence the wires cause to touch point determination.

Moreover, because the receiver electrodes (e.g. the first receiver electrode RX11 and the second receiver electrode RX12) perform touch sensing with the first transmitter electrode TX11 and the second transmitter electrode TX12 simultaneously, a capacitance variation sensed by the receiver electrodes (e.g. the first receiver electrode RX11 and the second receiver electrode RX12) is increased. In other words, in the case of the same horizontal sensing pitch and vertical sensing pitch, the capacitance variation sensed by the touch patterns 110 of this embodiment is approximately double.

With reference to FIG. 1A and FIG. 1B, in this embodiment, a touch panel 100a includes a plurality of touch patterns 120, for example, wherein electrodes of the touch patterns 120 are arranged in approximately the same manner as the touch patterns 110, and a difference is that the sequence of arrangement of the first receiver electrode RX11 and the second receiver electrode RX12 of each of the touch patterns 120 is opposite to the sequence of arrangement of the first receiver electrode RX11 and the second receiver electrode RX12 of the adjacent touch pattern 120 in the first direction D1. Moreover, in each of the touch patterns 120, the first receiver electrode RX11 and the second receiver electrode RX12 are respectively in contact with (equivalent to electrical connection) the first receiver electrode RX11 and the second receiver electrode RX12 of the two adjacent touch patterns 120 in the first direction D1. Therefore, the wires of the first receiver electrode RX11 and the second receiver electrode RX12 are in an S shape. Accordingly, the layout complexity and length of the wires are reduced to lower the overall hardware costs of the touch panel 100a.

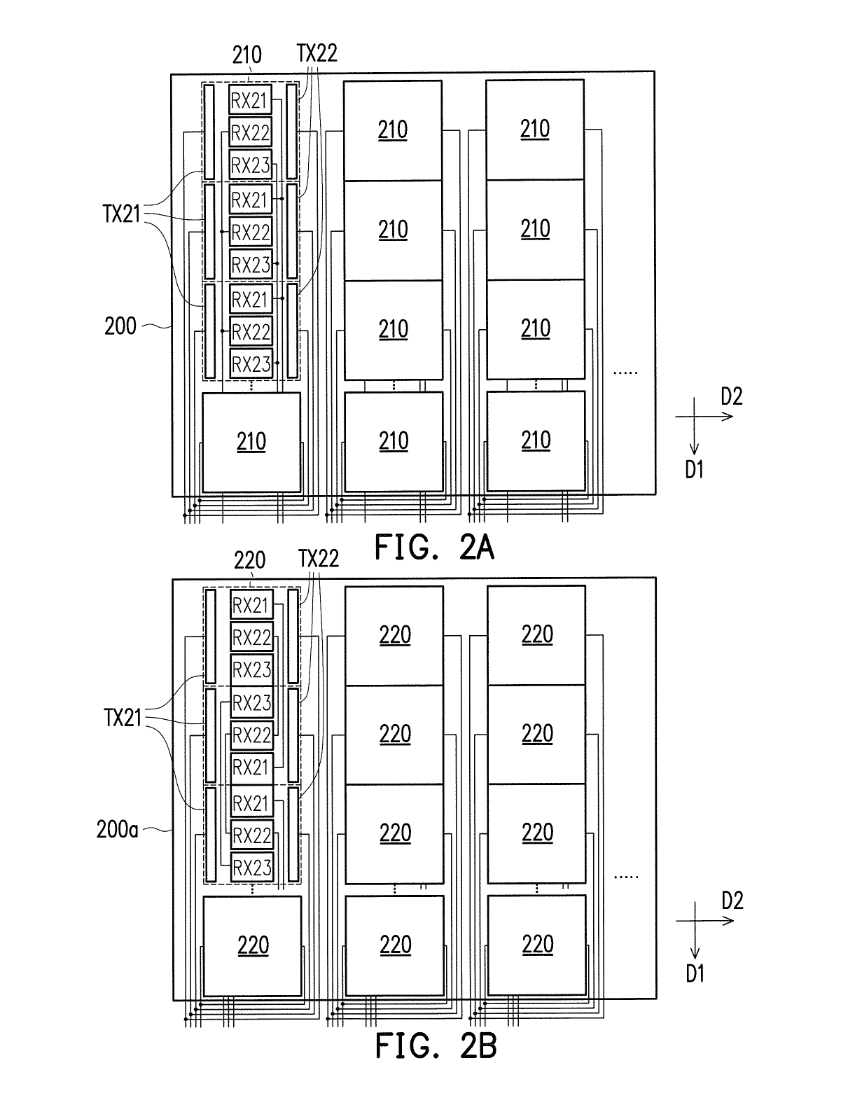

FIG. 2A and FIG. 2B are schematic structural views of a touch panel according to the second embodiment of the invention. With reference to FIG. 2A, in this embodiment, a touch panel 200 includes a plurality of touch patterns 210, for example, wherein the touch patterns 210 are arranged in an array and the touch patterns 210 respectively include a first transmitter electrode TX21, a second transmitter electrode TX22, and a plurality of receiver electrodes (e.g. a first receiver electrode RX21, a second receiver electrode RX22, and a third receiver electrode RX23). The first transmitter electrodes TX21, the second transmitter electrodes TX22, the first receiver electrodes RX21, the second receiver electrodes RX22, and the third receiver electrodes RX23 do not overlap each other and may be disposed in the same layer.

In each of the touch patterns 210, the first transmitter electrode TX21 and the second transmitter electrode TX22 are disposed opposite to each other in the second direction D2, and the first transmitter electrode TX21 is electrically connected with the second transmitter electrode TX22. That is, the first transmitter electrode TX21 and the second transmitter electrode TX22 of the same touch pattern 210 receive a driving signal simultaneously. The first receiver electrode RX21, the second receiver electrode RX22, and the third receiver electrode RX23 are disposed between the first transmitter electrode TX21 and the second transmitter electrode TX22, wherein the first receiver electrode RX21, the second receiver electrode RX22, and the third receiver electrode RX23 are arranged in sequence in the first direction D1 (e.g. perpendicular to the second direction D2), and the sequence of arrangement of the first receiver electrode RX21, the second receiver electrode RX22, and the third receiver electrode RX23 is the same for all the touch patterns 210.

Furthermore, the first receiver electrode RX21, the second receiver electrode RX22, and the third receiver electrode RX23 are respectively adjacent to the first transmitter electrode TX21 and the second transmitter electrode TX22. That is, the first receiver electrode RX21, the second receiver electrode RX22, and the third receiver electrode RX23 perform touch sensing with the first transmitter electrode TX21 and the second transmitter electrode TX22 simultaneously. In other words, a horizontal sensing pitch of the touch panel 200 is from the left side of the first transmitter electrode TX21 to the right side of the second transmitter electrode TX22; and a vertical sensing pitch of the touch panel 200 is equal to the length of the first receiver electrode RX21, the second receiver electrode RX22, or the third receiver electrode RX23 in the first direction D1.

In terms of the entire touch panel 200, the first transmitter electrodes TX21 are not connected with each other, and the second transmitter electrodes TX22 are not connected with each other, either. That is, the touch patterns 210 correspond to different driving signals respectively. The first receiver electrodes RX21 are electrically connected with each other, the second receiver electrodes RX22 are electrically connected with each other, and the third receiver electrodes RX23 are electrically connected with each other.

According to the above, wires connecting the receiver electrodes (e.g. the first receiver electrode RX21, the second receiver electrode RX22, and the third receiver electrode RX23) are respectively disposed between the receiver electrodes (e.g. the first receiver electrode RX21, the second receiver electrode RX22, and the third receiver electrode RX23) and the first transmitter electrode TX21 and between the receiver electrodes (e.g. the first receiver electrode RX21, the second receiver electrode RX22, and the third receiver electrode RX23) and the second transmitter electrode TX22. That is, every time touch sensing is performed, the receiver electrodes (e.g. the first receiver electrode RX21, the second receiver electrode RX22, and the third receiver electrode RX23) are affected by an equivalent capacitance of the wires. Therefore, a capacitance distribution of the touch panel 200 is uniformized to reduce the influence the wires cause to touch point determination. Moreover, because the receiver electrodes (e.g. the first receiver electrode RX21, the second receiver electrode RX22, and the third receiver electrode RX23) perform touch sensing with the first transmitter electrode TX21 and the second transmitter electrode TX22 simultaneously, a capacitance variation sensed by the receiver electrodes (e.g. the first receiver electrode RX21, the second receiver electrode RX22, and the third receiver electrode RX23) is increased.

With reference to FIG. 2A and FIG. 2B, in this embodiment, a touch panel 200a includes a plurality of touch patterns 220, for example, wherein electrodes of the touch patterns 220 are arranged in approximately the same manner as the touch patterns 210, and a difference is that the sequence of arrangement of the first receiver electrode RX21, the second receiver electrode RX22, and the third receiver electrode RX23 of each of the touch patterns 220 is opposite to the sequence of arrangement of the first receiver electrode RX21, the second receiver electrode RX22, and the third receiver electrode RX23 of the adjacent touch pattern 220 in the first direction D1.

Moreover, in each of the touch patterns 220, the first receiver electrode RX21 and the third receiver electrode RX23 are respectively in contact with (equivalent to electrical connection) the first receiver electrode RX21 and the third receiver electrode RX23 of the two adjacent touch patterns 220 in the first direction D1. Therefore, the wires of the first receiver electrode RX21, the second receiver electrode RX22, and the third receiver electrode RX23 are in an S shape. Accordingly, the layout complexity and length of the wires are reduced to lower the overall hardware costs of the touch panel 200a. In addition, the wires avoid passing through the areas where the first receiver electrode RX21, the second receiver electrode RX22, and the third receiver electrode RX23 are disposed, so as to prevent the arrangement of the wires from affecting the arrangement of the first receiver electrode RX21, the second receiver electrode RX22, and the third receiver electrode RX23.

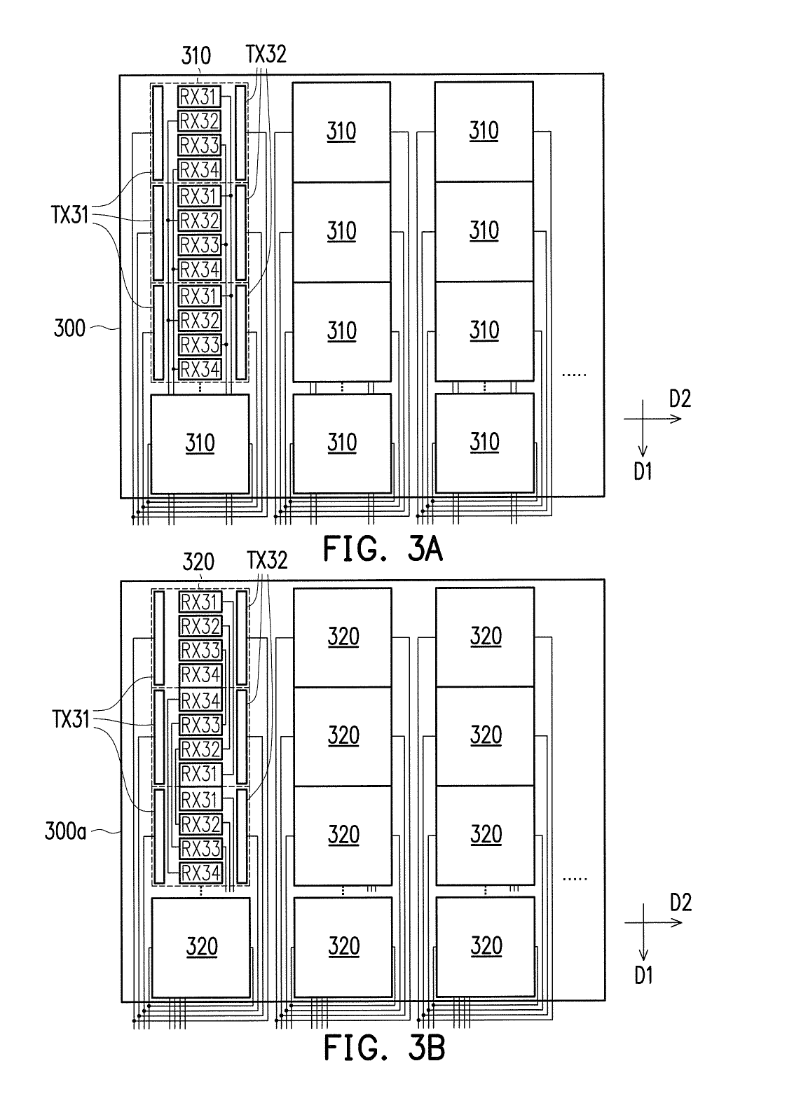

FIG. 3A and FIG. 3B are schematic structural views of a touch panel according to the third embodiment of the invention. With reference to FIG. 3A, in this embodiment, a touch panel 300 includes a plurality of touch patterns 310, for example, wherein the touch patterns 310 are arranged in an array and the touch patterns 310 respectively include a first transmitter electrode TX31, a second transmitter electrode TX32, and a plurality of receiver electrodes (e.g. a first receiver electrode RX31, a second receiver electrode RX32, a third receiver electrode RX33, and a fourth receiver electrode RX34). The first transmitter electrodes TX31, the second transmitter electrodes TX32, the first receiver electrodes RX31, the second receiver electrodes RX32, the third receiver electrodes RX33, and the fourth receiver electrodes RX34 do not overlap each other and may be disposed in the same layer.

In each of the touch patterns 310, the first transmitter electrode TX31 and the second transmitter electrode TX32 are disposed opposite to each other in the second direction D2, and the first transmitter electrode TX31 is electrically connected with the second transmitter electrode TX32. That is, the first transmitter electrode TX31 and the second transmitter electrode TX32 of the same touch pattern 310 receive a driving signal simultaneously. The first receiver electrode RX31, the second receiver electrode RX32, the third receiver electrode RX33, and the fourth receiver electrode RX34 are disposed between the first transmitter electrode TX31 and the second transmitter electrode TX32, wherein the first receiver electrode RX31, the second receiver electrode RX32, the third receiver electrode RX33, and the fourth receiver electrode RX34 are arranged in sequence in the first direction D1 (e.g. perpendicular to the second direction D2), and the sequence of arrangement of the first receiver electrode RX31, the second receiver electrode RX32, the third receiver electrode RX33, and the fourth receiver electrode RX34 is the same for all the touch patterns 310.

Furthermore, the first receiver electrode RX31, the second receiver electrode RX32, the third receiver electrode RX33, and the fourth receiver electrode RX34 are respectively adjacent to the first transmitter electrode TX31 and the second transmitter electrode TX32. That is, the first receiver electrode RX31, the second receiver electrode RX32, the third receiver electrode RX33, and the fourth receiver electrode RX34 perform touch sensing with the first transmitter electrode TX31 and the second transmitter electrode TX32 simultaneously. In other words, a horizontal sensing pitch of the touch panel 300 is from the left side of the first transmitter electrode TX31 to the right side of the second transmitter electrode TX32; and a vertical sensing pitch of the touch panel 300 is equal to the length of the first receiver electrode RX31, the second receiver electrode RX32, the third receiver electrode RX33, or the fourth receiver electrode RX34 in the first direction D1.

In terms of the entire touch panel 300, the first transmitter electrodes TX31 are not connected with each other, and the second transmitter electrodes TX32 are not connected with each other, either. That is, the touch patterns 310 correspond to different driving signals respectively. The first receiver electrodes RX31 are electrically connected with each other, the second receiver electrodes RX32 are electrically connected with each other, the third receiver electrodes RX33 are electrically connected with each other, and the fourth receiver electrodes RX34 are electrically connected with each other.

According to the above, wires connecting the receiver electrodes (e.g. the first receiver electrode RX31, the second receiver electrode RX32, the third receiver electrode RX33, and the fourth receiver electrode RX34) are respectively disposed between the receiver electrodes (e.g. the first receiver electrode RX31, the second receiver electrode RX32, the third receiver electrode RX33, and the fourth receiver electrode RX34) and the first transmitter electrode TX31 and between the receiver electrodes (e.g. the first receiver electrode RX31, the second receiver electrode RX32, the third receiver electrode RX33, and the fourth receiver electrode RX34) and the second transmitter electrode TX32. That is, every time touch sensing is performed, the receiver electrodes (e.g. the first receiver electrode RX31, the second receiver electrode RX32, the third receiver electrode RX33, and the fourth receiver electrode RX34) are affected by an equivalent capacitance of the wires. Therefore, a capacitance distribution of the touch panel 300 is uniformized to reduce the influence the wires cause to touch point determination. Moreover, because the receiver electrodes (e.g. the first receiver electrode RX31, the second receiver electrode RX32, the third receiver electrode RX33, and the fourth receiver electrode RX34) perform touch sensing with the first transmitter electrode TX31 and the second transmitter electrode TX32 simultaneously, a capacitance variation sensed by the receiver electrodes (e.g. the first receiver electrode RX31, the second receiver electrode RX32, the third receiver electrode RX33, and the fourth receiver electrode RX34) is increased.

With reference to FIG. 3A and FIG. 3B, in this embodiment, a touch panel 300a includes a plurality of touch patterns 320, for example, wherein electrodes of the touch patterns 320 are arranged in approximately the same manner as the touch patterns 310, and a difference is that the sequence of arrangement of the first receiver electrode RX31, the second receiver electrode RX32, the third receiver electrode RX33, and the fourth receiver electrode RX34 of each of the touch patterns 320 is opposite to the sequence of arrangement of the first receiver electrode RX31, the second receiver electrode RX32, the third receiver electrode RX33, and the fourth receiver electrode RX34 of the adjacent touch pattern 320 in the first direction D1.

Moreover, in each of the touch patterns 320, the first receiver electrode RX31 and the fourth receiver electrode RX34 are respectively in contact with (equivalent to electrical connection) the first receiver electrode RX31 and the fourth receiver electrode RX34 of the two adjacent touch patterns 320 in the first direction D1. Therefore, the wires of the first receiver electrode RX31, the second receiver electrode RX32, the third receiver electrode RX33, and the fourth receiver electrode RX34 are in an S shape. Accordingly, the layout complexity and length of the wires are reduced to lower the overall hardware costs of the touch panel 300a. In addition, the wires avoid passing through the areas where the first receiver electrode RX31, the second receiver electrode RX32, the third receiver electrode RX33, and the fourth receiver electrode RX34 are disposed, so as to prevent the arrangement of the wires from affecting the arrangement of the first receiver electrode RX31, the second receiver electrode RX32, the third receiver electrode RX33, and the fourth receiver electrode RX34.

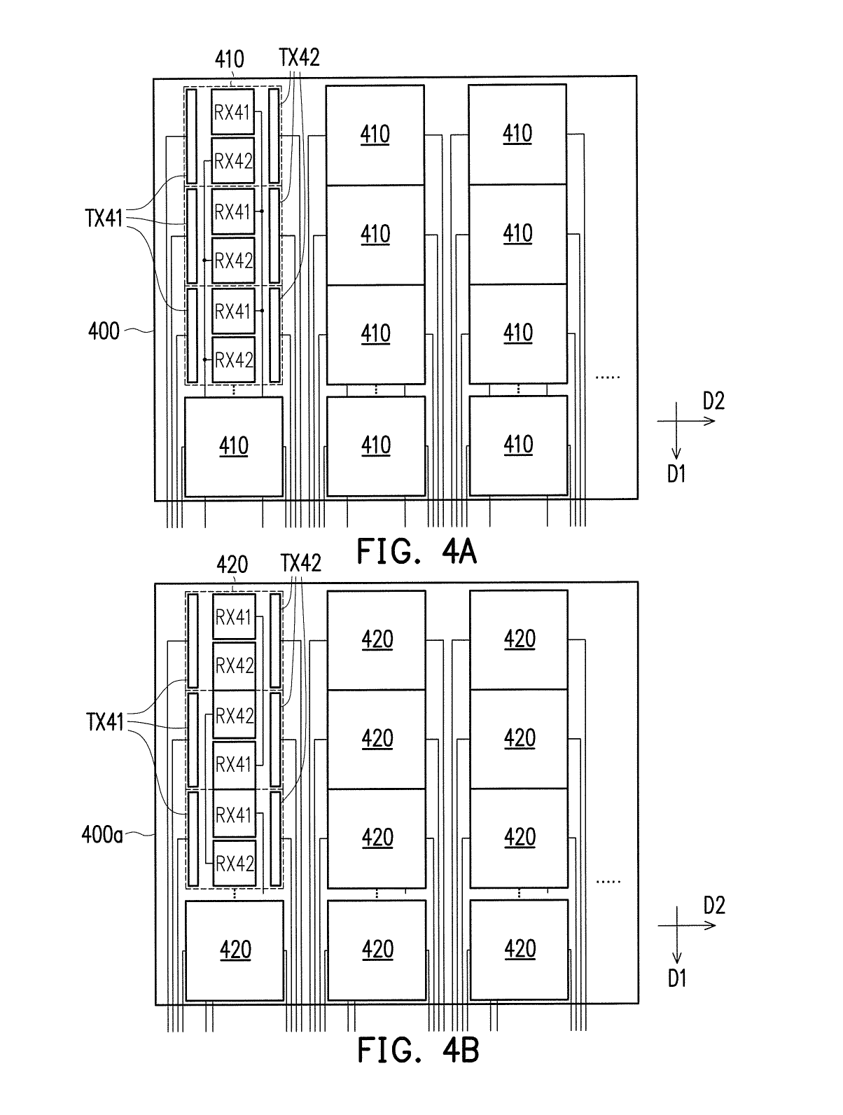

FIG. 4A and FIG. 4B are schematic structural views of a touch panel according to the fourth embodiment of the invention. With reference to FIG. 1A and FIG. 4A, in this embodiment, a touch panel 400 includes a plurality of touch patterns 410, for example, wherein the touch patterns 410 are arranged in an array and the touch patterns 410 respectively include a first transmitter electrode TX41, a second transmitter electrode TX42, and a plurality of receiver electrodes (e.g. a first receiver electrode RX41 and a second receiver electrode RX42).

Electrodes of the touch patterns 410 are arranged in a manner similar to the touch patterns 110, and a difference is that the first transmitter electrode TX41 and the second transmitter electrode TX42 of the same touch pattern 410 are not connected with each other. That is, each of the touch patterns 410 corresponds to two driving signals. Here, a horizontal sensing pitch of the touch panel 400 is from the left side of the first transmitter electrode TX41 to a central point of the receiver electrodes (e.g. the first receiver electrode RX41 and the second receiver electrode RX42), or from the central point of the receiver electrodes (e.g. the first receiver electrode RX41 and the second receiver electrode RX42) to the right side of the second transmitter electrode TX42; and a vertical sensing pitch of the touch panel 400 is equal to the length of the first receiver electrode RX41 or the second receiver electrode RX42 in the first direction D1.

According to the above, the first transmitter electrode TX41 and the second transmitter electrode TX42 of each of the touch patterns 410 share the same group of receiver electrodes (e.g. the first receiver electrode RX41 and the second receiver electrode RX42). Therefore, the wires of the receiver electrodes are saved to reduce the overall hardware costs of the touch panel 400.

With reference to FIG. 4A and FIG. 4B, in this embodiment, a touch panel 400a includes a plurality of touch patterns 420, for example, wherein electrodes of the touch patterns 420 are arranged in approximately the same manner as the touch patterns 410, and a difference is that the sequence of arrangement of the first receiver electrode RX41 and the second receiver electrode RX42 of each of the touch patterns 420 is opposite to the sequence of arrangement of the first receiver electrode RX41 and the second receiver electrode RX42 of the adjacent touch pattern 420 in the first direction D1. Moreover, in each of the touch patterns 420, the first receiver electrode RX41 and the second receiver electrode RX42 are respectively in contact with (equivalent to electrical connection) the first receiver electrode RX41 and the second receiver electrode RX42 of the two adjacent touch patterns 420 in the first direction D1. Therefore, the wires of the first receiver electrode RX41 and the second receiver electrode RX42 are in an S shape. Accordingly, the layout complexity and length of the wires are reduced to lower the overall hardware costs of the touch panel 400a.

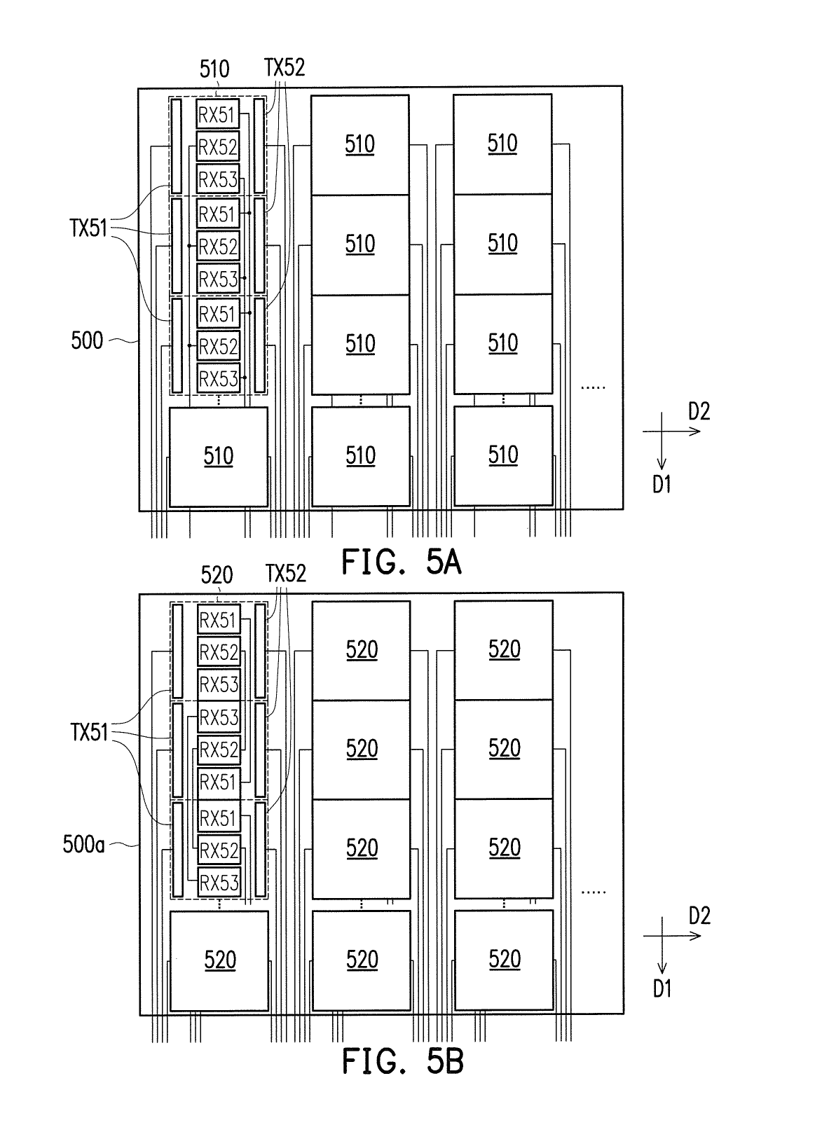

FIG. 5A and FIG. 5B are schematic structural views of a touch panel according to the fifth embodiment of the invention. With reference to FIG. 2A and FIG. 5A, in this embodiment, a touch panel 500 includes a plurality of touch patterns 510, for example, wherein the touch patterns 510 are arranged in an array and the touch patterns 510 respectively include a first transmitter electrode TX51, a second transmitter electrode TX52, and a plurality of receiver electrodes (e.g. a first receiver electrode RX51, a second receiver electrode RX52, and a third receiver electrode RX53).

Electrodes of the touch patterns 510 are arranged in a manner similar to the touch patterns 210, and a difference is that the first transmitter electrode TX51 and the second transmitter electrode TX52 of the same touch pattern 510 are not connected with each other. That is, each of the touch patterns 510 corresponds to two driving signals. Here, a horizontal sensing pitch of the touch panel 500 is from the left side of the first transmitter electrode TX51 to a central point of the receiver electrodes (e.g. the first receiver electrode RX51, the second receiver electrode RX52, and the third receiver electrode RX53), or from the central point of the receiver electrodes (e.g. the first receiver electrode RX51, the second receiver electrode RX52, and the third receiver electrode RX53) to the right side of the second transmitter electrode TX52; and a vertical sensing pitch of the touch panel 500 is equal to the length of the receiver electrodes (e.g. the first receiver electrode RX51, the second receiver electrode RX52, and the third receiver electrode RX53) in the first direction D1.

According to the above, the first transmitter electrode TX51 and the second transmitter electrode TX52 of each of the touch patterns 510 share the same group of receiver electrodes (e.g. the first receiver electrode RX51, the second receiver electrode RX52, and the third receiver electrode RX53). Therefore, the wires of the receiver electrodes are saved to reduce the overall hardware costs of the touch panel 500.

With reference to FIG. 5A and FIG. 5B, in this embodiment, a touch panel 500a includes a plurality of touch patterns 520, for example, wherein electrodes of the touch patterns 520 are arranged in approximately the same manner as the touch patterns 510, and a difference is that the sequence of arrangement of the first receiver electrode RX51, the second receiver electrode RX52, and the third receiver electrode RX53 of each of the touch patterns 520 is opposite to the sequence of arrangement of the first receiver electrode RX51, the second receiver electrode RX52, and the third receiver electrode RX53 of the adjacent touch pattern 520 in the first direction D1.

Moreover, in each of the touch patterns 520, the first receiver electrode RX51 and the third receiver electrode RX53 are respectively in contact with (equivalent to electrical connection) the first receiver electrode RX51 and the third receiver electrode RX53 of the two adjacent touch patterns 520 in the first direction D1. Therefore, the wires of the first receiver electrode RX51, the second receiver electrode RX52, and the third receiver electrode RX53 are in an S shape. Accordingly, the layout complexity and length of the wires are reduced to lower the overall hardware costs of the touch panel 500a. In addition, the wires avoid passing through the areas where the first receiver electrode RX51, the second receiver electrode RX52, and the third receiver electrode RX53 are disposed, so as to prevent the arrangement of the wires from affecting the arrangement of the first receiver electrode RX51, the second receiver electrode RX52, and the third receiver electrode RX53.

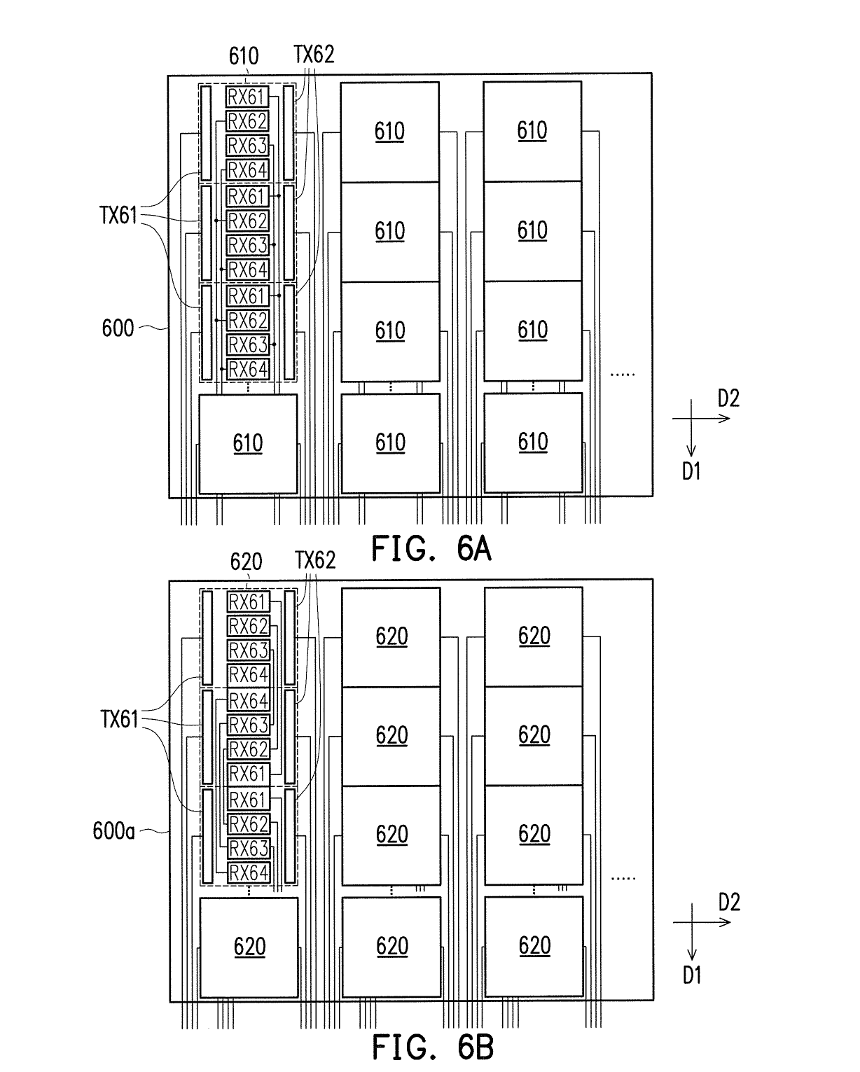

FIG. 6A and FIG. 6B are schematic structural views of a touch panel according to the sixth embodiment of the invention. With reference to FIG. 3A and FIG. 6A, in this embodiment, a touch panel 600 includes a plurality of touch patterns 610, for example, wherein the touch patterns 610 are arranged in an array and the touch patterns 610 respectively include a first transmitter electrode TX61, a second transmitter electrode TX62, and a plurality of receiver electrodes (e.g. a first receiver electrode RX61, a second receiver electrode RX62, a third receiver electrode RX63, and a fourth receiver electrode RX64).

Electrodes of the touch patterns 610 are arranged in a manner similar to the touch patterns 310, and a difference is that the first transmitter electrode TX61 and the second transmitter electrode TX62 of the same touch pattern 610 are not connected with each other. That is, each of the touch patterns 610 corresponds to two driving signals. Here, a horizontal sensing pitch of the touch panel 600 is from the left side of the first transmitter electrode TX61 to a central point of the receiver electrodes (e.g. the first receiver electrode RX61, the second receiver electrode RX62, the third receiver electrode RX63, and the fourth receiver electrode RX64), or from the central point of the receiver electrodes (e.g. the first receiver electrode RX61, the second receiver electrode RX62, the third receiver electrode RX63, and the fourth receiver electrode RX64) to the right side of the second transmitter electrode TX62; and a vertical sensing pitch of the touch panel 600 is equal to the length of the receiver electrodes (e.g. the first receiver electrode RX61, the second receiver electrode RX62, the third receiver electrode RX63, and the fourth receiver electrode RX64) in the first direction D1.

According to the above, the first transmitter electrode TX61 and the second transmitter electrode TX62 of each of the touch patterns 610 share the same group of receiver electrodes (e.g. the first receiver electrode RX61, the second receiver electrode RX62, the third receiver electrode RX63, and the fourth receiver electrode RX64). Therefore, the wires of the receiver electrodes are saved to reduce the overall hardware costs of the touch panel 600.

With reference to FIG. 6A and FIG. 6B, in this embodiment, a touch panel 600a includes a plurality of touch patterns 620, for example, wherein electrodes of the touch patterns 620 are arranged in approximately the same manner as the touch patterns 610, and a difference is that the sequence of arrangement of the first receiver electrode RX61, the second receiver electrode RX62, the third receiver electrode RX63, and the fourth receiver electrode RX64 of each of the touch patterns 620 is opposite to the sequence of arrangement of the first receiver electrode RX61, the second receiver electrode RX62, the third receiver electrode RX63, and the fourth receiver electrode RX64 of the adjacent touch pattern 620 in the first direction D1.

Moreover, in each of the touch patterns 620, the first receiver electrode RX61 and the fourth receiver electrode RX64 are respectively in contact with (equivalent to electrical connection) the first receiver electrode RX61 and the fourth receiver electrode RX64 of the two adjacent touch patterns 620 in the first direction D1. Therefore, the wires of the first receiver electrode RX61, the second receiver electrode RX62, the third receiver electrode RX63, and the fourth receiver electrode RX64 are in an S shape. Accordingly, the layout complexity and length of the wires are reduced to lower the overall hardware costs of the touch panel 600a. In addition, the wires avoid passing through the areas where the first receiver electrode RX61, the second receiver electrode RX62, the third receiver electrode RX63, and the fourth receiver electrode RX64 are disposed, so as to prevent the arrangement of the wires from affecting the arrangement of the first receiver electrode RX61, the second receiver electrode RX62, the third receiver electrode RX63, and the fourth receiver electrode RX64.

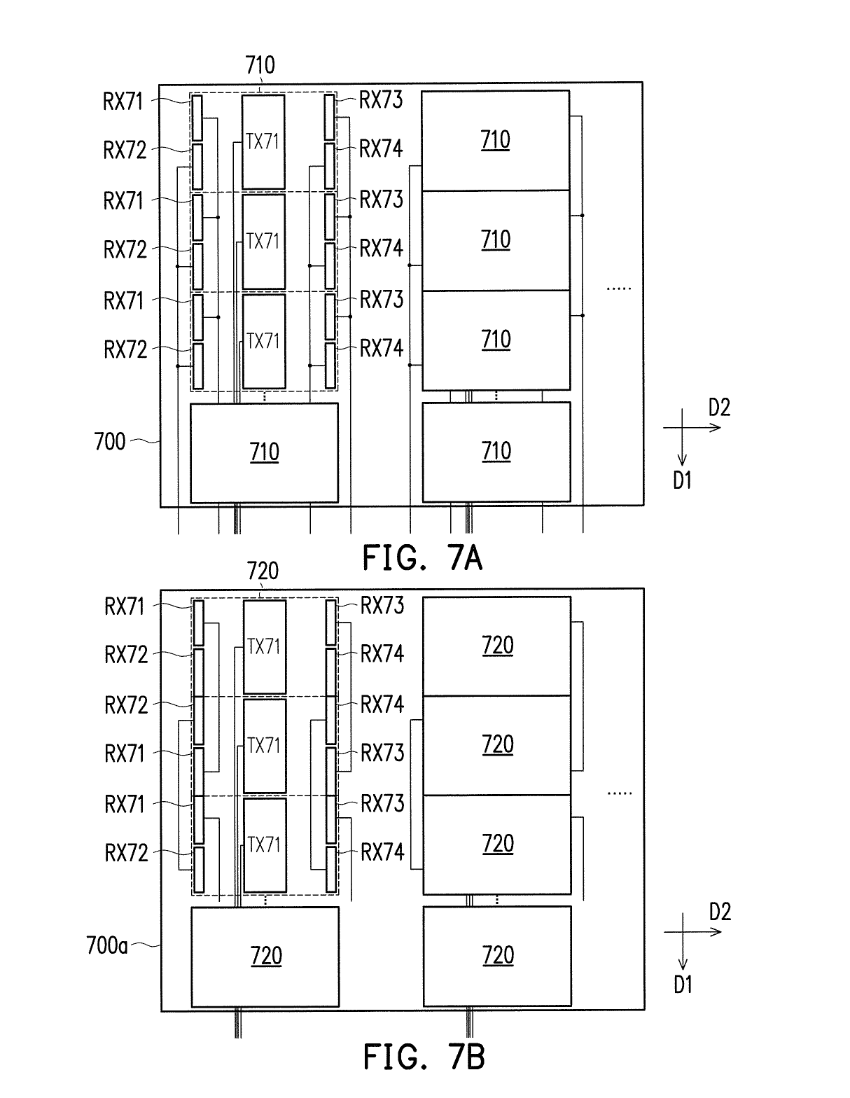

FIG. 7A and FIG. 7B are schematic structural views of a touch panel according to the seventh embodiment of the invention. With reference to FIG. 7A, in this embodiment, a touch panel 700 includes a plurality of touch patterns 710, for example, wherein the touch patterns 710 are arranged in an array and the touch patterns 710 respectively include a transmitter electrode TX71 and a plurality of receiver electrodes (e.g. a first receiver electrode RX71, a second receiver electrode RX72, a third receiver electrode RX73, and a fourth receiver electrode RX74). The first receiver electrode RX71, the second receiver electrode RX72, the third receiver electrode RX73, and the fourth receiver electrode RX74 are disposed evenly on a first side (e.g. the left side of the figures) and a second side (e.g. the right side of the figures opposite to the left side in the second direction) of the transmitter electrode TX71, and the first receiver electrode RX71, the second receiver electrode RX72, the third receiver electrode RX73, and the fourth receiver electrode RX74 are all adjacent to the transmitter electrode TX71.

The transmitter electrode TX71, the first receiver electrode RX71, the second receiver electrode RX72, the third receiver electrode RX73, and the fourth receiver electrode RX74 do not overlap each other. The transmitter electrodes of the touch patterns 710 are not connected with each other. That is, the touch patterns 710 correspond to different driving signals. Moreover, the first receiver electrodes RX71 are electrically connected with each other, the second receiver electrodes RX72 are electrically connected with each other, the third receiver electrodes RX73 are electrically connected with each other, and the fourth receiver electrodes RX74 are electrically connected with each other.

In this embodiment, the first receiver electrode RX71 and the second receiver electrode RX72 are disposed on the left side of the transmitter electrode TX71 and arranged in sequence in the first direction D1. The sequence of arrangement of the first receiver electrode RX71 and the second receiver electrode RX72 is the same for all the touch patterns 710. The third receiver electrode RX73 and the fourth receiver electrode RX74 are disposed on the right side of the transmitter electrode TX71 and arranged in sequence in the first direction D1. The sequence of arrangement of the third receiver electrode RX73 and the fourth receiver electrode RX74 is the same for all the touch patterns 710. Here, a horizontal sensing pitch of the touch panel 700 is from a central line of the transmitter electrode TX71 to the left side of the first receiver electrode RX71 or the second receiver electrode RX72, or from the central line of the transmitter electrode TX71 to the right side of the third receiver electrode RX73 or the fourth receiver electrode RX74; and a vertical sensing pitch of the touch panel 700 is equal to the length of the first receiver electrode RX71, the second receiver electrode RX72, the third receiver electrode RX73, or the fourth receiver electrode RX74 in the first direction D1.

According to the above, the first receiver electrode RX71, the second receiver electrode RX72, the third receiver electrode RX73, and the fourth receiver electrode RX74 of the same touch pattern 710 share the transmitter electrode TX71. Therefore, the number of the wires of the transmitter electrode TX71 is reduced to lower the overall hardware costs of the touch panel 700.

With reference to FIG. 7A and FIG. 7B, in this embodiment, a touch panel 700a includes a plurality of touch patterns 720, for example, wherein electrodes of the touch patterns 720 are arranged in approximately the same manner as the touch patterns 710, and a difference is that the sequence of arrangement of the first receiver electrode RX71 and the second receiver electrode RX72 of each of the touch patterns 720 is opposite to the sequence of arrangement of the first receiver electrode RX71 and the second receiver electrode RX72 of the adjacent touch pattern 720 in the first direction D1, and the sequence of arrangement of the third receiver electrode RX73 and the fourth receiver electrode RX74 of each of the touch patterns 720 is opposite to the sequence of arrangement of the third receiver electrode RX73 and the fourth receiver electrode RX74 of the adjacent touch pattern 720 in the first direction D1. Moreover, in each of the touch patterns 720, the first receiver electrode RX71, the second receiver electrode RX72, the third receiver electrode RX73, and the fourth receiver electrode RX74 are respectively in contact with (equivalent to electrical connection) the first receiver electrode RX71, the second receiver electrode RX72, the third receiver electrode RX73, and the fourth receiver electrode RX74 of the two adjacent touch patterns 720 in the first direction D1. Therefore, the wires of the first receiver electrode RX71, the second receiver electrode RX72, the third receiver electrode RX73, and the fourth receiver electrode RX74 are in an S shape. Accordingly, the layout complexity and length of the wires are reduced to lower the overall hardware costs of the touch panel 700a.

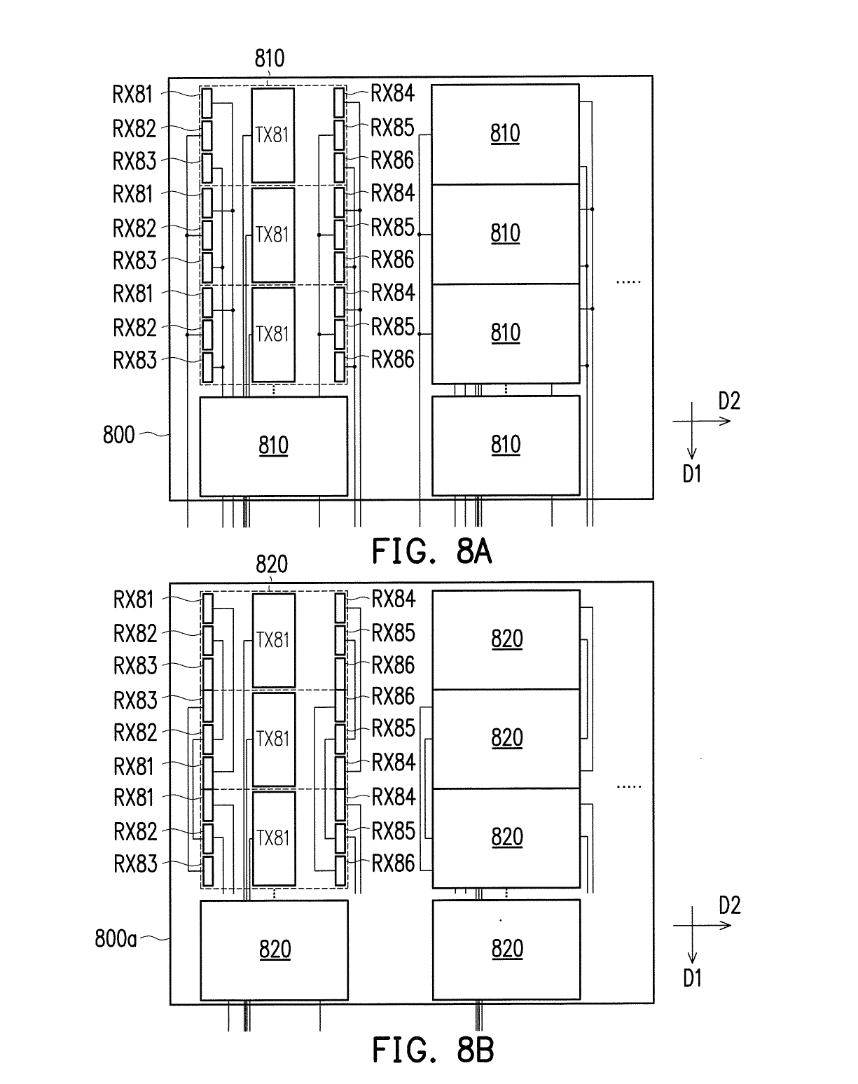

FIG. 8A and FIG. 8B are schematic structural views of a touch panel according to the eighth embodiment of the invention. With reference to FIG. 8A, in this embodiment, a touch panel 800 includes a plurality of touch patterns 810, for example, wherein the touch patterns 810 are arranged in an array and the touch patterns 810 respectively include a transmitter electrode TX81 and a plurality of receiver electrodes (e.g. a first receiver electrode RX81, a second receiver electrode RX82, a third receiver electrode RX83, a fourth receiver electrode RX84, a fifth receiver electrode RX85, and a sixth receiver electrode RX86). The first receiver electrode RX81, the second receiver electrode RX82, the third receiver electrode RX83, the fourth receiver electrode RX84, the fifth receiver electrode RX85, and the sixth receiver electrode RX86 are disposed evenly on a first side (e.g. the left side of the figures) and a second side (e.g. the right side of the figures opposite to the left side in the second direction) of the transmitter electrode TX81, and the first receiver electrode RX81, the second receiver electrode RX82, the third receiver electrode RX83, the fourth receiver electrode RX84, the fifth receiver electrode RX85, and the sixth receiver electrode RX86 are all adjacent to the transmitter electrode TX81.

The transmitter electrode TX81, the first receiver electrode RX81, the second receiver electrode RX82, the third receiver electrode RX83, the fourth receiver electrode RX84, the fifth receiver electrode RX85, and the sixth receiver electrode RX86 do not overlap each other. The transmitter electrodes TX81 of the touch patterns 810 are not connected with each other. That is, the touch patterns 810 correspond to different driving signals. Moreover, the first receiver electrodes RX81 are electrically connected with each other, the second receiver electrodes RX82 are electrically connected with each other, the third receiver electrodes RX83 are electrically connected with each other, the fourth receiver electrodes RX84 are electrically connected with each other, the fifth receiver electrodes RX85 are electrically connected with each other, and the sixth receiver electrodes RX86 are electrically connected with each other.

In this embodiment, the first receiver electrode RX81, the second receiver electrode RX82, and the third receiver electrode RX83 are disposed on the left side of the transmitter electrode TX81 and arranged in sequence in the first direction D1. The sequence of arrangement of the first receiver electrode RX81, the second receiver electrode RX82, and the third receiver electrode RX83 is the same for all the touch patterns 810. The fourth receiver electrode RX84, the fifth receiver electrode RX85, and the sixth receiver electrode RX86 are disposed on the right side of the transmitter electrode TX81 and arranged in sequence in the first direction D1. The sequence of arrangement of the fourth receiver electrode RX84, the fifth receiver electrode RX85, and the sixth receiver electrode RX86 is the same for all the touch patterns 810. Here, a horizontal sensing pitch of the touch panel 800 is from a central line of the transmitter electrode TX81 to the left side of the first receiver electrode RX81, the second receiver electrode RX82, or the third receiver electrode RX83, or from the central line of the transmitter electrode TX81 to the right side of the fourth receiver electrode RX84, the fifth receiver electrode RX85, or the sixth receiver electrode RX86; and a vertical sensing pitch of the touch panel 800 is equal to the length of the first receiver electrode RX81, the second receiver electrode RX82, the third receiver electrode RX83, the fourth receiver electrode RX84, the fifth receiver electrode RX85, or the sixth receiver electrode RX86 in the first direction D1.

According to the above, the first receiver electrode RX81, the second receiver electrode RX82, the third receiver electrode RX83, the fourth receiver electrode RX84, the fifth receiver electrode RX85, and the sixth receiver electrode RX86 of the same touch pattern 810 share the transmitter electrode TX81. Therefore, the number of the wires of the transmitter electrode TX81 is reduced to lower the overall hardware costs of the touch panel 800.

With reference to FIG. 8A and FIG. 8B, in this embodiment, a touch panel 800a includes a plurality of touch patterns 820, for example, wherein electrodes of the touch patterns 820 are arranged in approximately the same manner as the touch patterns 810, and a difference is that the sequence of arrangement of the first receiver electrode RX81, the second receiver electrode RX82, and the third receiver electrode RX83 of each of the touch patterns 820 is opposite to the sequence of arrangement of the first receiver electrode RX81, the second receiver electrode RX82, and the third receiver electrode RX83 of the adjacent touch pattern 820 in the first direction D1, and the sequence of arrangement of the fourth receiver electrode RX84, the fifth receiver electrode RX85, and the sixth receiver electrode RX86 of each of the touch patterns 820 is opposite to the sequence of arrangement of the fourth receiver electrode RX84, the fifth receiver electrode RX85, and the sixth receiver electrode RX86 of the adjacent touch pattern 820 in the first direction D1.

Moreover, in each of the touch patterns 820, the first receiver electrode RX81, the third receiver electrode RX83, the fourth receiver electrode RX84, and the sixth receiver electrode RX86 are respectively in contact with (equivalent to electrical connection) the first receiver electrode RX81, the third receiver electrode RX83, the fourth receiver electrode RX84, and the sixth receiver electrode RX86 of the two adjacent touch patterns 820 in the first direction D1. Therefore, the wires of the first receiver electrode RX81, the second receiver electrode RX82, the third receiver electrode RX83, the fourth receiver electrode RX84, the fifth receiver electrode RX85, and the sixth receiver electrode RX86 are in an S shape. Accordingly, the layout complexity and length of the wires are reduced to lower the overall hardware costs of the touch panel 800a. In addition, the wires avoid passing through the areas where the first receiver electrode RX81, the second receiver electrode RX82, the third receiver electrode RX83, the fourth receiver electrode RX84, the fifth receiver electrode RX85, and the sixth receiver electrode RX86 are disposed, so as to prevent the arrangement of the wires from affecting the arrangement of the first receiver electrode RX81, the second receiver electrode RX82, the third receiver electrode RX83, the fourth receiver electrode RX84, the fifth receiver electrode RX85, and the sixth receiver electrode RX86.

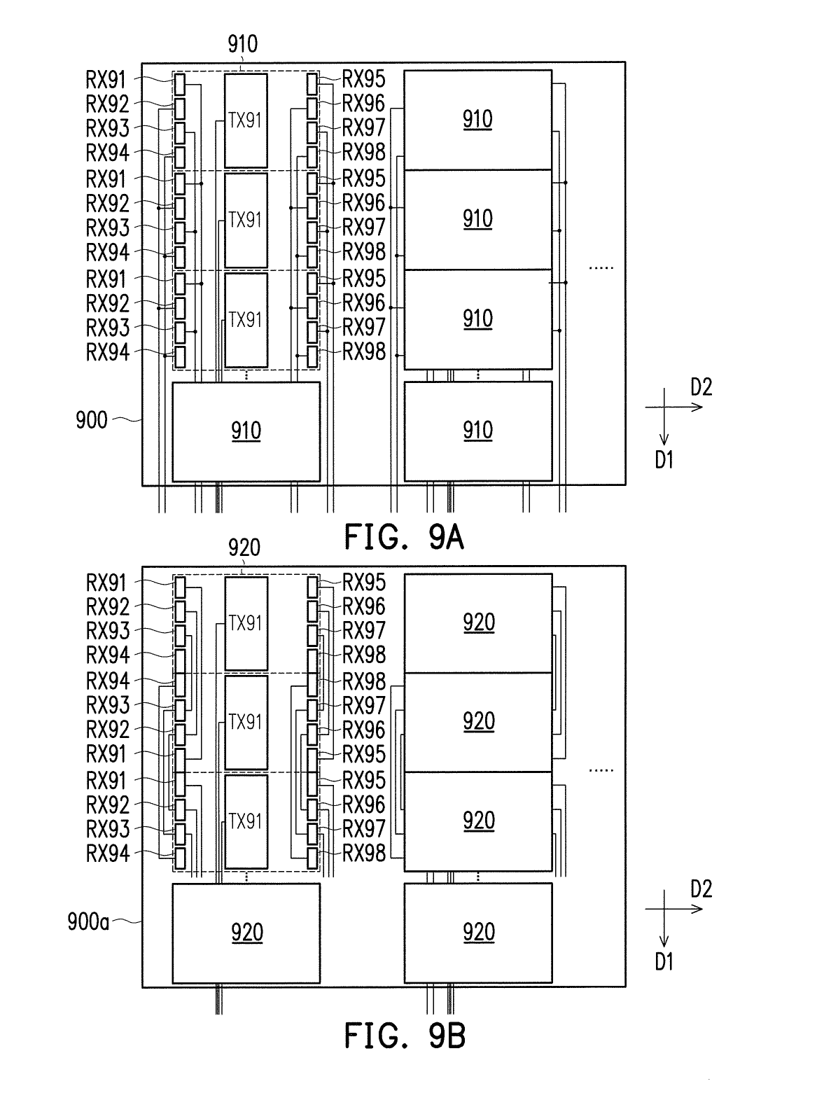

FIG. 9A and FIG. 9B are schematic structural views of a touch panel according to the ninth embodiment of the invention. With reference to FIG. 9A, in this embodiment, a touch panel 900 includes a plurality of touch patterns 910, for example, wherein the touch patterns 910 are arranged in an array and the touch patterns 910 respectively include a transmitter electrode TX91 and a plurality of receiver electrodes (e.g. a first receiver electrode RX91, a second receiver electrode RX92, a third receiver electrode RX93, a fourth receiver electrode RX94, a fifth receiver electrode RX95, a sixth receiver electrode RX96, a seventh receiver electrode RX97, and an eighth receiver electrode RX98). The first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98 are disposed evenly on a first side (e.g. the left side of the figures) and a second side (e.g. the right side of the figures opposite to the left side in the second direction) of the transmitter electrode TX91, and the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98 are all adjacent to the transmitter electrode TX91.

The transmitter electrode TX91, the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98 do not overlap each other. The transmitter electrodes TX91 of the touch patterns 910 are not connected with each other. That is, the touch patterns 910 correspond to different driving signals. Moreover, the first receiver electrodes RX91 are electrically connected with each other, the second receiver electrodes RX92 are electrically connected with each other, the third receiver electrodes RX93 are electrically connected with each other, the fourth receiver electrodes RX94 are electrically connected with each other, the fifth receiver electrodes RX95 are electrically connected with each other, the sixth receiver electrodes RX96 are electrically connected with each other, the seventh receiver electrodes RX97 are electrically connected with each other, and the eighth receiver electrodes RX98 are electrically connected with each other.

In this embodiment, the first receiver electrode RX91, the second receiver electrode RX92, the third receiver electrode RX93, and the fourth receiver electrode RX94 are disposed on the left side of the transmitter electrode TX91 and arranged in sequence in the first direction D1. The sequence of arrangement of the first receiver electrode RX91, the second receiver electrode RX92, the third receiver electrode RX93, and the fourth receiver electrode RX94 is the same for all the touch patterns 910. The fifth receiver electrode RX95, the sixth receiver electrode RX96, the seventh receiver electrode RX97, and the eighth receiver electrode RX98 are disposed on the right side of the transmitter electrode TX91 and arranged in sequence in the first direction D1. The sequence of arrangement of the fifth receiver electrode RX95, the sixth receiver electrode RX96, the seventh receiver electrode RX97, and the eighth receiver electrode RX98 is the same for all the touch patterns 910. Here, a horizontal sensing pitch of the touch panel 900 is from a central line of the transmitter electrode TX91 to the left side of the first receiver electrode RX91, the second receiver electrode RX92, the third receiver electrode RX93, or the fourth receiver electrode RX94, or from the central line of the transmitter electrode TX91 to the right side of the fifth receiver electrode RX95, the sixth receiver electrode RX96, the seventh receiver electrode RX97, or the eighth receiver electrode RX98; and a vertical sensing pitch of the touch panel 900 is equal to the length of the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, or the eighth receiver electrode RX98 in the first direction D1.

According to the above, the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98 of the same touch pattern 910 share the transmitter electrode TX91. Therefore, the number of the wires of the transmitter electrode TX91 is reduced to lower the overall hardware costs of the touch panel 900.

With reference to FIG. 9A and FIG. 9B, in this embodiment, a touch panel 900a includes a plurality of touch patterns 920, for example, wherein electrodes of the touch patterns 920 are arranged in approximately the same manner as the touch patterns 910, and a difference is that the sequence of arrangement of the first receiver electrode RX91, the second receiver electrode RX92, the third receiver electrode RX93, and the fourth receiver electrode RX94 of each of the touch patterns 920 is opposite to the sequence of arrangement of the first receiver electrode RX91, the second receiver electrode RX92, the third receiver electrode RX93, and the fourth receiver electrode RX94 of the adjacent touch pattern 920 in the first direction D1, and the sequence of arrangement of the fifth receiver electrode RX95, the sixth receiver electrode RX96, the seventh receiver electrode RX97, and the eighth receiver electrode RX98 of each of the touch patterns 920 is opposite to the sequence of arrangement of the fifth receiver electrode RX95, the sixth receiver electrode RX96, the seventh receiver electrode RX97, and the eighth receiver electrode RX98 of the adjacent touch pattern 920 in the first direction D1.

Moreover, in each of the touch patterns 920, the first receiver electrode RX91, the fourth receiver electrode RX94, the fifth receiver electrode RX95, and the eighth receiver electrode RX98 are respectively in contact with (equivalent to electrical connection) the first receiver electrode RX91, the fourth receiver electrode RX94, the fifth receiver electrode RX95, and the eighth receiver electrode RX98 of the two adjacent touch patterns 920 in the first direction D1. Therefore, the wires of the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98 are in an S shape. Accordingly, the layout complexity and length of the wires are reduced to lower the overall hardware costs of the touch panel 900a. In addition, the wires avoid passing through the areas where the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98 are disposed, so as to prevent the arrangement of the wires from affecting the arrangement of the first receiver electrode RX91, the second receiver electrode RX92, the third receiver electrode RX93, the fourth receiver electrode RX94, the fifth receiver electrode RX95, the sixth receiver electrode RX96, the seventh receiver electrode RX97, and the eighth receiver electrode RX98.

To sum up, according to the touch panel and the electrode arranging method thereof provided by the embodiments of the invention, in each of the touch patterns, the transmitter electrodes that are electrically connected with each other are disposed to surround multiple receiver electrodes, so as to improve the capacitance variation sensed due to touch. Moreover, in each of the touch patterns, the transmitter electrodes that are not connected with each other share multiple receiver electrodes, or the receiver electrodes share the same transmitter electrode, so as to reduce the number of the wires and thereby lower the overall hardware costs of the touch panel.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A touch panel, comprising:
a plurality of touch patterns arranged in an array and each comprising:
a first transmitter electrode;
a second transmitter electrode disposed in parallel to the first transmitter electrode; and
a plurality of receiver electrodes disposed between the first transmitter electrode and the second transmitter electrode, and each of the receiver electrodes being respectively adjacent to the first transmitter electrode and the second transmitter electrode,
wherein the first transmitter electrode, the second transmitter electrode, and the receiver electrodes do not overlap each other; the first transmitter electrodes of the touch patterns are not connected with each other; and the second transmitter electrodes of the touch patterns are not connected with each other.

2. The touch panel according to claim 1, wherein, in each of the touch patterns, the first transmitter electrode is electrically connected with the second transmitter electrode.

3. The touch panel according to claim 2, wherein, in each of the touch patterns, the receiver electrodes comprise a first receiver electrode and a second receiver electrode that are arranged in sequence in a first direction, wherein the first receiver electrodes of the touch patterns are electrically connected with each other and the second receiver electrodes of the touch patterns are electrically connected with each other.

4. The touch panel according to claim 3, wherein, in each of the touch patterns, the receiver electrodes further comprise a third receiver electrode, and the first receiver electrode, the second receiver electrode, and the third receiver electrode are arranged in sequence in the first direction, wherein the third receiver electrodes of the touch patterns are electrically connected with each other.

5. The touch panel according to claim 4, wherein a sequence of arrangement of the first receiver electrode, the second receiver electrode, and the third receiver electrode of each of the touch patterns is the same as a sequence of arrangement of the first receiver electrode, the second receiver electrode, and the third receiver electrode of the adjacent touch pattern in the first direction.

6. The touch panel according to claim 4, wherein the sequence of arrangement of the first receiver electrode, the second receiver electrode, and the third receiver electrode of each of the touch patterns is opposite to the sequence of arrangement of the first receiver electrode, the second receiver electrode, and the third receiver electrode of the adjacent touch pattern in the first direction.

7. The touch panel according to claim 6, wherein one of the first receiver electrode and the third receiver electrode of each of the touch patterns is in contact with one of the first receiver electrode and the third receiver electrode of the adjacent touch pattern in the first direction.

8. The touch panel according to claim 4, wherein, in each of the touch patterns, the receiver electrodes further comprise a fourth receiver electrode, and the first receiver electrode, the second receiver electrode, the third receiver electrode, and the fourth receiver electrode are arranged in sequence in the first direction, wherein the fourth receiver electrodes of the touch patterns are electrically connected with each other.

9. The touch panel according to claim 8, wherein a sequence of arrangement of the first receiver electrode, the second receiver electrode, the third receiver electrode, and the fourth receiver electrode of each of the touch patterns is the same as a sequence of arrangement of the first receiver electrode, the second receiver electrode, the third receiver electrode, and the fourth receiver electrode of the adjacent touch pattern in the first direction.

10. The touch panel according to claim 8, wherein the sequence of arrangement of the first receiver electrode, the second receiver electrode, the third receiver electrode, and the fourth receiver electrode of each of the touch patterns is opposite to the sequence of arrangement of the first receiver electrode, the second receiver electrode, the third receiver electrode, and the fourth receiver electrode of the adjacent touch pattern in the first direction.

11. The touch panel according to claim 10, wherein one of the first receiver electrode and the fourth receiver electrode of each of the touch patterns is in contact with one of the first receiver electrode and the fourth receiver electrode of the adjacent touch pattern in the first direction.

12. The touch panel according to claim 1, wherein, in each of the touch patterns, the first transmitter electrode is not connected with the second transmitter electrode.

13. The touch panel according to claim 12, wherein, in each of the touch patterns, the receiver electrodes comprise a first receiver electrode and a second receiver electrode that are arranged in sequence in the first direction, wherein the first receiver electrodes of the touch patterns are electrically connected with each other and the second receiver electrodes of the touch patterns are electrically connected with each other.

14. The touch panel according to claim 13, wherein, in each of the touch patterns, the receiver electrodes further comprise a third receiver electrode, and the first receiver electrode, the second receiver electrode, and the third receiver electrode are arranged in sequence in the first direction, wherein the third receiver electrodes of the touch patterns are electrically connected with each other.

15. The touch panel according to claim 14, wherein a sequence of arrangement of the first receiver electrode, the second receiver electrode, and the third receiver electrode of each of the touch patterns is the same as a sequence of arrangement of the first receiver electrode, the second receiver electrode, and the third receiver electrode of the adjacent touch pattern in the first direction.

16. The touch panel according to claim 14, wherein the sequence of arrangement of the first receiver electrode, the second receiver electrode, and the third receiver electrode of each of the touch patterns is opposite to the sequence of arrangement of the first receiver electrode, the second receiver electrode, and the third receiver electrode of the adjacent touch pattern in the first direction.

17. The touch panel according to claim 16, wherein one of the first receiver electrode and the third receiver electrode of each of the touch patterns is in contact with one of the first receiver electrode and the third receiver electrode of the adjacent touch pattern in the first direction.

18. The touch panel according to claim 14, wherein, in each of the touch patterns, the receiver electrodes further comprise a fourth receiver electrode, and the first receiver electrode, the second receiver electrode, the third receiver electrode, and the fourth receiver electrode are arranged in sequence in the first direction, wherein the fourth receiver electrodes of the touch patterns are electrically connected with each other.

19. The touch panel according to claim 18, wherein a sequence of arrangement of the first receiver electrode, the second receiver electrode, the third receiver electrode, and the fourth receiver electrode of each of the touch patterns is the same as a sequence of arrangement of the first receiver electrode, the second receiver electrode, the third receiver electrode, and the fourth receiver electrode of the adjacent touch pattern in the first direction.

20. The touch panel according to claim 18, wherein the sequence of arrangement of the first receiver electrode, the second receiver electrode, the third receiver electrode, and the fourth receiver electrode of each of the touch patterns is opposite to the sequence of arrangement of the first receiver electrode, the second receiver electrode, the third receiver electrode, and the fourth receiver electrode of the adjacent touch pattern in the first direction.

21. The touch panel according to claim 20, wherein one of the first receiver electrode and the fourth receiver electrode of each of the touch patterns is in contact with one of the first receiver electrode and the fourth receiver electrode of the adjacent touch pattern in the first direction.

22. A touch panel, comprising:
a plurality of touch patterns arranged in an array and each comprising:
a transmitter electrode; and
a plurality of receiver electrodes disposed evenly on a first side and a second side of the transmitter electrode and adjacent to the transmitter electrode,
wherein the first side is opposite to the second side; the transmitter electrode and the receiver electrodes do not overlap each other; and the transmitter electrodes of the touch patterns are not connected with each other.

23. The touch panel according to claim 22, wherein, in each of the touch patterns, the receiver electrodes comprise a first receiver electrode, a second receiver electrode, a third receiver electrode, and a fourth receiver electrode; and the first receiver electrode and the second receiver electrode are disposed on the first side and arranged in sequence in a first direction, and the third receiver electrode and the fourth receiver electrode are disposed on the second side and arranged in sequence in the first direction, wherein the first receiver electrodes of the touch patterns are electrically connected with each other, the second receiver electrodes of the touch patterns are electrically connected with each other, the third receiver electrodes of the touch patterns are electrically connected with each other, and the fourth receiver electrodes of the touch patterns are electrically connected with each other.

24. The touch panel according to claim 22, wherein, in each of the touch patterns, the receiver electrodes comprise a first receiver electrode, a second receiver electrode, a third receiver electrode, a fourth receiver electrode, a fifth receiver electrode, and a sixth receiver electrode; and the first receiver electrode, the second receiver electrode, and the third receiver electrode are disposed on the first side and arranged in sequence in a first direction, and the fourth receiver electrode, the fifth receiver electrode, and the sixth receiver electrode are disposed on the second side and arranged in sequence in the first direction, wherein the first receiver electrodes of the touch patterns are electrically connected with each other, the second receiver electrodes of the touch patterns are electrically connected with each other, the third receiver electrodes of the touch patterns are electrically connected with each other, the fourth receiver electrodes of the touch patterns are electrically connected with each other, the fifth receiver electrodes of the touch patterns are electrically connected with each other, and the sixth receiver electrodes of the touch patterns are electrically connected with each other.

25. The touch panel according to claim 24, wherein a sequence of arrangement of the first receiver electrode, the second receiver electrode, and the third receiver electrode of each of the touch patterns is the same as a sequence of arrangement of the first receiver electrode, the second receiver electrode, and the third receiver electrode of the adjacent touch pattern in the first direction; and a sequence of arrangement of the fourth receiver electrode, the fifth receiver electrode, and the sixth receiver electrode of each of the touch patterns is the same as a sequence of arrangement of the fourth receiver electrode, the fifth receiver electrode, and the sixth receiver electrode of the adjacent touch pattern in the first direction.

26. The touch panel according to claim 24, wherein the sequence of arrangement of the first receiver electrode, the second receiver electrode, and the third receiver electrode of each of the touch patterns is opposite to the sequence of arrangement of the first receiver electrode, the second receiver electrode, and the third receiver electrode of the adjacent touch pattern in the first direction; and the sequence of arrangement of the fourth receiver electrode, the fifth receiver electrode, and the sixth receiver electrode of each of the touch patterns is opposite to the sequence of arrangement of the fourth receiver electrode, the fifth receiver electrode, and the sixth receiver electrode of the adjacent touch pattern in the first direction.

27. The touch panel according to claim 26, wherein one of the first receiver electrode and the third receiver electrode of each of the touch patterns is in contact with one of the first receiver electrode and the third receiver electrode of the adjacent touch pattern in the first direction; and one of the fourth receiver electrode and the sixth receiver electrode of each of the touch patterns is in contact with one of the fourth receiver electrode and the sixth receiver electrode of the adjacent touch pattern in the first direction.

28. The touch panel according to claim 22, wherein, in each of the touch patterns, the receiver electrodes comprise a first receiver electrode, a second receiver electrode, a third receiver electrode, a fourth receiver electrode, a fifth receiver electrode, a sixth receiver electrode, a seventh receiver electrode, and an eighth receiver electrode; and the first receiver electrode, the second receiver electrode, the third receiver electrode, and the fourth receiver electrode are disposed on the first side and arranged in sequence in a first direction, and the fifth receiver electrode, the sixth receiver electrode, the seventh receiver electrode, and the eighth receiver electrode are disposed on the second side and arranged in sequence in the first direction, wherein the first receiver electrodes of the touch patterns are electrically connected with each other, the second receiver electrodes of the touch patterns are electrically connected with each other, the third receiver electrodes of the touch patterns are electrically connected with each other, the fourth receiver electrodes of the touch patterns are electrically connected with each other, the fifth receiver electrodes of the touch patterns are electrically connected with each other, the sixth receiver electrodes of the touch patterns are electrically connected with each other, the seventh receiver electrodes of the touch patterns are electrically connected with each other, and the eighth receiver electrodes of the touch patterns are electrically connected with each other.

29. The touch panel according to claim 28, wherein a sequence of arrangement of the first receiver electrode, the second receiver electrode, the third receiver electrode, and the fourth receiver electrode of each of the touch patterns is the same as a sequence of arrangement of the first receiver electrode, the second receiver electrode, the third receiver electrode, and the fourth receiver electrode of the adjacent touch pattern in the first direction; and a sequence of arrangement of the fifth receiver electrode, the sixth receiver electrode, the seventh receiver electrode, and the eighth receiver electrode of each of the touch patterns is the same as a sequence of arrangement of the fifth receiver electrode, the sixth receiver electrode, the seventh receiver electrode, and the eighth receiver electrode of the adjacent touch pattern in the first direction.

30. The touch panel according to claim 28, wherein the sequence of arrangement of the first receiver electrode, the second receiver electrode, the third receiver electrode, and the fourth receiver electrode of each of the touch patterns is opposite to the sequence of arrangement of the first receiver electrode, the second receiver electrode, the third receiver electrode, and the fourth receiver electrode of the adjacent touch pattern in the first direction; and the sequence of arrangement of the fifth receiver electrode, the sixth receiver electrode, the seventh receiver electrode, and the eighth receiver electrode of each of the touch patterns is opposite to the sequence of arrangement of the fifth receiver electrode, the sixth receiver electrode, the seventh receiver electrode, and the eighth receiver electrode of the adjacent touch pattern in the first direction.

31. The touch panel according to claim 30, wherein one of the first receiver electrode and the fourth receiver electrode of each of the touch patterns is in contact with one of the first receiver electrode and the fourth receiver electrode of the adjacent touch pattern in the first direction; and one of the fifth receiver electrode and the eighth receiver electrode of each of the touch patterns is in contact with one of the fifth receiver electrode and the eighth receiver electrode of the adjacent touch pattern in the first direction.

32. An electrode arranging method for a touch panel, which comprises a plurality of touch patterns each comprising a first transmitter electrode, a second transmitter electrode, and a plurality of receiver electrodes, and the electrode arranging method comprising:
disposing the second transmitter electrode in parallel to the first transmitter electrode; and
disposing the receiver electrodes between the first transmitter electrode and the second transmitter electrode, wherein each of the receiver electrodes is respectively adjacent to the first transmitter electrode and the second transmitter electrode; the first transmitter electrode, the second transmitter electrode, and the receiver electrodes do not overlap each other; and the first transmitter electrodes of the touch patterns are not connected with each other, and the second transmitter electrodes of the touch patterns are not connected with each other.

33. An electrode arranging method for a touch panel, which comprises a plurality of touch patterns each comprising a transmitter electrode and a plurality of receiver electrodes, and the electrode arranging method comprising:
evenly disposing the receiver electrodes on a first side and a second side of the transmitter electrode such that the receiver electrodes are adjacent to the transmitter electrode, wherein the first side is opposite to the second side; the transmitter electrode and the receiver electrodes do not overlap each other; and the transmitter electrodes of the touch patterns are not connected with each other.
